(19) United States
(12) Patent Application Publication
(10) Pub. No.: US 2024/0211428 A1
(43) Pub. Date: Jun. 27, 2024

(54) INTERMEDIARY DEVICE FOR VEHICLE/MOBILE DEVICE COMMUNICATION AND METHODS OF MAKING AND USING

(71) Applicant: National Products, Inc., Seattle, WA (US)

(72) Inventor: Scott Anderson, Seattle, WA (US)

(21) Appl. No.: 18/086,509

(22) Filed: Dec. 21, 2022

(51) Int. Cl. G06F 13/42; G06F 13/38

(52) U.S. Cl. CPC G06F 13/4282; G06F 13/382; G06F 2213/0042; G06F 2213/40

(57) ABSTRACT

An intermediary device is described for receiving vehicular data from a vehicle and transmitting the vehicular data to a mobile device, where the vehicle and the mobile device are external to the intermediary device. The intermediary device includes an interpreter to receive the vehicular data from the vehicle and translate the vehicular data into a format that can be understood by the mobile device; a DC/DC converter to convert power from an external DC source for operation of the intermediary device; and an interface for coupling to the mobile device and delivering the translated vehicular data.

### FIELD

The present invention is directed to device for communication between vehicle systems and a mobile device which can then communicate externally. The present invention is also directed to a device for communicating vehicular data through a coupled mobile device to an external receiver.

### BACKGROUND

Fleet management systems (FMS) transmit vehicular information using a dedicated telematics box inside the vehicle. The telematics box interfaces to the vehicle's ignition and other digital and analog inputs/outputs, records that event with a timestamp, then sends that information along with GPS information to an external receiver. Companies also use tablets or other mobile devices as the visual interface and display of driving records and compliance and to manage inventory and other data. The tablets or other mobile devices are also typically internet-enabled.

### BRIEF SUMMARY

One embodiment is an intermediary device configured for receiving vehicular data from a vehicle and transmitting the vehicular data to a mobile device, where the vehicle and the mobile device are external to the intermediary device. The intermediary device includes an interpreter configured to receive the vehicular data from the vehicle and translate the vehicular data into a format that can be understood by the mobile device; a DC/DC converter configured to convert power from an external DC source for operation of the intermediary device; and an interface configured for coupling to the mobile device and delivering the translated vehicular data.

In at least some embodiments, the interpreter is a CAN bus interpreter. In at least some embodiments, the interface is a USB interface. In at least some embodiments, the intermediary device is configured for charging the mobile device via the DC/DC converter when the intermediary device is coupled to a DC source and to the mobile device.

In at least some embodiments, the intermediary device further includes a microprocessor coupled to the interpreter, DC/DC converter, and interface. In at least some embodiments, the intermediary device further includes a memory coupled to the microprocessor. In at least some embodiments, the microprocessor and memory are configured for storing the vehicular data in the memory when the mobile device is unavailable for receiving the vehicular data.

Another embodiment is a system that includes any of the intermediary devices described above and the mobile device coupled, or coupleable, to the intermediary device.

In at least some embodiments, the system further includes the vehicle coupled, or coupleable, to the intermediary device. In at least some embodiments, the vehicle includes a DC source coupled, or coupleable, to the DC/DC converter of the intermediary device. In at least some embodiments, the mobile device is configured to transmit the vehicular data to an external receiver which is external to the vehicle. In at least some embodiments, the mobile device is further configured to transmit GPS data with the vehicular data to the external receiver.

In at least some embodiments, the intermediary device further includes a microprocessor coupled to the interpreter, DC/DC converter, and interface and a memory coupled to the microprocessor. In at least some embodiments, the microprocessor and memory are configured for storing the vehicular data in the memory when the mobile device is unavailable for receiving the vehicular data.

A further embodiment is a method of sharing vehicular data of a vehicle using any of the intermediary devices described above. The method includes delivering the vehicular data by the interpreter of the intermediary device, wherein the intermediary device is disposed in the vehicle; translating, by the interpreter, the vehicular data into a format that can be understood by a mobile device; and delivering the vehicular data from the intermediary device to the mobile device, wherein the mobile device is disposed in the vehicle.

In at least some embodiments, the method further includes charging the mobile device using power from the DC/DC converter of the intermediary device. In at least some embodiments, the method further includes transmitting the vehicular data from the mobile device to an external receiver which is external to the vehicle. In at least some embodiments, the transmitting including transmitting GPS data with the vehicular data from the mobile device to the external receiver.

In at least some embodiments, the method further includes storing the vehicular data in a memory of the intermediary device. In at least some embodiments, the delivering includes delivering the vehicular data from the memory of the intermediary device to the mobile device.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic block diagram of one embodiment of a system for receiving vehicular data from a vehicle and transmitting the vehicular data to a mobile device, according to the invention;

FIG. 2 is a schematic block diagram of one embodiment of an intermediary device for receiving vehicular data from a vehicle and transmitting the vehicular data to a mobile device and connections of the intermediary device to the vehicle, mobile device, and DC source;

FIG. 3A is a schematic perspective view of one embodiment of a cover for a mobile device; and

FIG. 3B is schematic perspective view of the cover of FIG. 3B from a different angle.

### DETAILED DESCRIPTION

The present invention is directed to device for communication between vehicle systems and a mobile device which can then communicate externally. The present invention is also directed to a device for communicating vehicular data through a coupled mobile device to an external receiver.

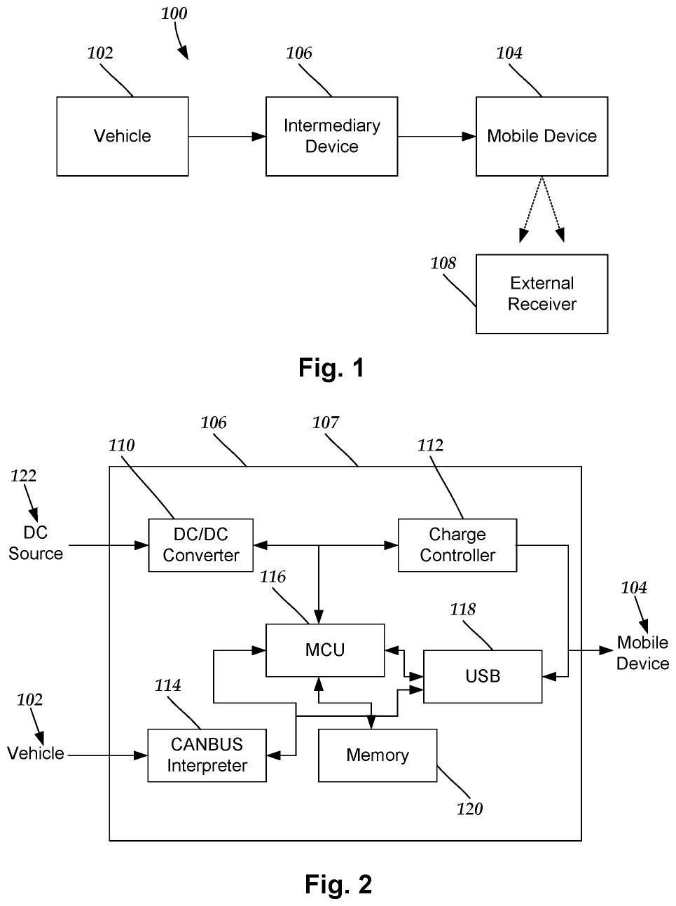

FIG. 1 illustrates one embodiment of a system 100 including a vehicle 102, a mobile device 104, an intermediary device 106, and an external receiver 108, which can include the Internet or any other network. The external receiver 108 is external to the vehicle 102. In at least some embodiments, during operation of the system 100, the intermediary device 106 and the mobile device 104 are both disposed in the vehicle 102. In at least some embodiments, the intermediary device 106 has a wired connection to the vehicle 102 through a cord/connector arrangement or a hardwired arrangement. In at least some embodiments, the intermediary device 106 has a wired connection to the mobile device through a cord/connector arrangement or a hardwired arrangement.

The vehicle 102 can be any suitable vehicle including, but not limited to, a truck, van, car, motorcycle, moped, motorized bicycle, boat, ship, airplane, helicopter, bicycle, or any other motorized vehicle or non-motorized vehicle, or the like. In at least some embodiments, the vehicle includes a DC power source that can be used by the intermediary device 106 and mobile device 104, as described in more detail below. The vehicle includes an on-board processor that generates vehicular data such as, but not limited to, vehicle identification number or other identifier (e.g., a fleet vehicle identifier), vehicle parameters, diagnostic codes, diagnostic states, speed data, steering angle, engine temperature, start/stop data, vehicle alarm data, vehicle tilt data, transmission or gear data, lane assist and collision avoidance data, vehicle safety or collision data, weather data, brake data, or the like or any combination thereof. Often vehicular data is provided using the CAN (Controller Area Network) bus standard. The CAN bus standard is used herein as an example, but it will be understood that any other standard for vehicular data can be used in place, or in addition to, the CAN bus standard.

The mobile device 104 can be any suitable mobile device including, but not limited to, a smartphone, cellular or mobile phone, tablet, personal data assistant, laptop computer, or the like. In at least some embodiments, the mobile device 104 has a USB connector, such as a USB 3.1 or USB Type C connector or any other suitable USB connector, for coupling to external devices, such as the intermediary device 106. It will be understood that the present invention is applicable to other types of connectors.

Preferably, the mobile device 104 can generate GPS data to provide a location of the mobile device 104 and, therefore, the vehicle 102. In at least some embodiments, part of the data transmitted by the mobile device is location data, such as GPS data.

The mobile device 104 can transmit the vehicular data, as well as data from the mobile device and intermediary device 106, to the external receiver 108 using radiofrequency, cellular, WiFi, Bluetooth™, or any other suitable communications method or protocol. In at least some embodiments, the transmission can be continuous or continuous as long as the mobile device 104 is operating and coupled to the vehicle 102 via the intermediary device 106. In at least some embodiments, the transmission can be intermittent. In such embodiments, the transmission may be periodic or aperiodic. In at least some embodiments, at least some transmissions may be event-driven (e.g., a change in vehicle operation).

Examples of vehicular data that can be transmitted are listed above. Transmittable data from the intermediary device 106 can include, but is not limited to, a serial number or other identifier of the intermediary device, a log status, or the like or any combination thereof. Transmittable data from the intermediary device 106 can include, but is not limited to, device serial number of other identifier, software version, battery state, communications state, GPS and other position data (including information such as, latitude, longitude, speed, heading/direction, elevation, HDOP, VDOP, or the like), GPS status, historical GPS and other position data, time stamp, or the like or any combination thereof.

In at least some embodiments, the external receiver 108 can receive the transmitted signals directly from the mobile device 104. In at least some embodiments, the external receiver 108 can receive the transmitted signals through one or more networks including, but not limited to, one or more cellular networks, the Internet, one or more wide area networks, one or more local area networks, or the like or any combination thereof. In at least some embodiments, there may be one or more intermediary receivers or transmitters between the external receiver 108 and the mobile device 104.

In at least some embodiments, the intermediary device 106 includes a DC/DC USB power supply to provide power to the mobile device 104 and a CAN bus to USB converter to convert CAN bus vehicular data from the onboard electronics of the vehicle 102 to be received via USB by the mobile device 104.

FIG. 2 illustrates one embodiment of an intermediary device 106. The illustrated intermediary device 106 includes a DC/DC controller 110, a charge controller 112, a CAN bus interpreter 114, a microcontroller unit (MCU) 116, a USB interface 118, and an optional memory 120. In at least some embodiments, the intermediary device 106 includes a housing 107 to house some or all of the components. It will be understood that other embodiments of the intermediary device 106 can include fewer, more, or different components.

The DC/DC converter 110 receives power from a DC source 122 such as, for example, from the vehicle through a vehicular DC outlet coupled to the vehicle's battery or power system. Other DC sources 122 can be used. In at least some embodiments, the intermediary device 106 includes a cord for coupling to the DC source 122. In other embodiments, the intermediary device 106 includes a connector for receiving a connector of a cord for coupling to the DC source 122. In at least some embodiments, the DC/DC converter 110 is a buck converter or step-down converter to step-down the voltage from the DC source 122. The DC/DC converter 110 provides power for the intermediary device 106 and my provide power for charging or operation of the mobile device 104. In at least some embodiments, the intermediary device 106 may also be capable of receiving power from the mobile device 104 when, for example, the vehicle 102 is not operating.

The charge controller 112 controls the USB charging of the mobile device 104 using the power from the DC/DC converter 110. In at least some embodiments, the DC/DC controller 110 and charge controller 112 can be combined.

The CAN bus interpreter 114 is coupled, or coupleable, to the vehicle 102 and the vehicle's electronics. One example of a CAN bus interpreter 114 is ELM327. The CAN bus interpreter 114 translates the vehicular data from the CAN bus standard into a form that can be transmitted via USB to the mobile device 104. In at least some embodiments, the CAN bus interpreter 114 can be part of the MCU 116. In at least some embodiments, the intermediary device 106 includes a cord for coupling to the vehicle 102. In other embodiments, the intermediary device 106 includes a connector for receiving a connector of a cord for coupling to the vehicle 102.

The USB interface 118 is coupled, or coupleable, to the mobile device 104. In at least some embodiments, the USB interface 118 is a USB to UART interface (for example, a serial UART interface) for receiving data from the CAN bus interpreter 114 and transmitting the data to the mobile device 104. In at least some embodiments, the intermediary device 106 includes a cord for coupling to the mobile device 104. In other embodiments, the intermediary device 106 includes a connector for receiving a connector of a cord for coupling to the mobile device 104. Although a USB interface 118 is exemplified herein, it will be understood that any other suitable interface or connectors can be used between the intermediary device 106 and the mobile device 104.

The MCU 116 can include, or be, a microprocessor and can control operation of the other components of the intermediary device 106. In at least some embodiments, the MCU 116 may also provide random access memory (RAM) for the intermediary device 106. The memory 120 can be any suitable memory device including, but not limited to, RAM, ROM, EEPROM, flash memory, or other memory technology. In at least some embodiments, the memory 120 can be used to store vehicular data when the mobile device 104 is not coupled to the intermediary device 106 or otherwise unavailable.

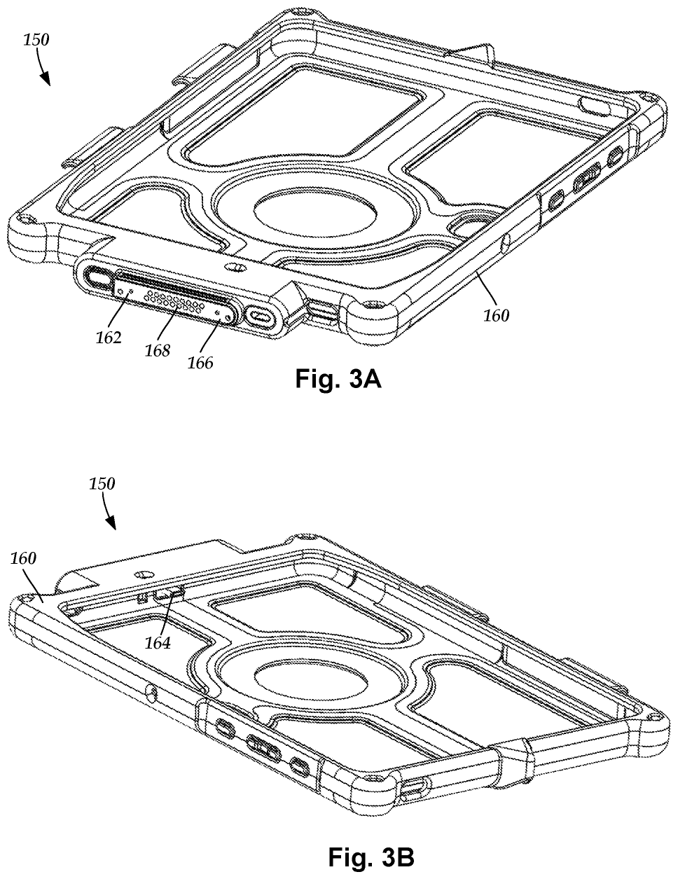

In at least some other embodiments, the mobile device 104 is disposed, or disposable, in a cover 150 with a flexible shell 160 for receiving and holding the mobile device. One embodiment of a cover 150 is illustrated in FIGS. 3A and 3B. In at least some embodiments, the cover 150 includes an adapter 162 that has a connector 164 (FIG. 3B) of a type compatible with the connector on the mobile device for coupling the adapter to the mobile device. The adapter 162 also includes a contactor 166 with contacts 168 for coupling to the intermediary device 106 through a cord, a docking station, or the like or any combination thereof. Examples of covers 150 for a mobile device 104 are described in U.S. Pat. Nos. 9,195,279; 9,331,444; 9,529,387; 9,602,639; 9,632,535; 9,706,026; 10,389,399; 10,050,658; 10,054,984; 10,454,515; 10,630,334; 10,666,309; 10,778,275 10,812,643; 11,029,731; 11,076,032; 11,165,458; 11, 277,506; and 11,289,864 and U.S. Patent Applications Publication Nos. 2021/0391678 and 2021/0392773, all of which are incorporated herein by reference in their entireties. It will be understood that covers without an adapter can also be used.

The above specification provides a description of the manufacture and use of the invention. Since many embodiments of the invention can be made without departing from the spirit and scope of the invention, the invention also resides in the claims hereinafter appended.

What is claimed as new and desired to be protected by Letters Patent of the United States is:

1. An intermediary device configured for receiving vehicular data from a vehicle and transmitting the vehicular data to a mobile device, wherein the vehicle and the mobile device are external to the intermediary device, the intermediary device comprising:
an interpreter configured to receive the vehicular data from the vehicle and translate the vehicular data into a format that can be understood by the mobile device;
a DC/DC converter configured to convert power from an external DC source for operation of the intermediary device; and
an interface configured for coupling to the mobile device and delivering the translated vehicular data.

2. The intermediary device of claim 1, wherein the interpreter is a CAN bus interpreter.

3. The intermediary device of claim 1, wherein the interface is a USB interface.

4. The intermediary device of claim 1, further comprising a microprocessor coupled to the interpreter, DC/DC converter, and interface.

5. The intermediary device of claim 4, further comprising a memory coupled to the microprocessor.

6. The intermediary device of claim 5, wherein the microprocessor and memory are configured for storing the vehicular data in the memory when the mobile device is unavailable for receiving the vehicular data.

7. The intermediary device of claim 1, wherein the intermediary device is configured for charging the mobile device via the DC/DC converter when the intermediary device is coupled to a DC source and to the mobile device.

8. A system, comprising:
the intermediary device of claim 1; and
the mobile device coupled, or coupleable, to the intermediary device.

9. The system of claim 8, further comprising the vehicle coupled, or coupleable, to the intermediary device.

10. The system of claim 9, wherein the vehicle comprises a DC source coupled, or coupleable, to the DC/DC converter of the intermediary device.

11. The system of claim 8, wherein the mobile device is configured to transmit the vehicular data to an external receiver which is external to the vehicle.

12. The system of claim 11, wherein the mobile device is further configured to transmit GPS data with the vehicular data to the external receiver.

13. The system of claim 8, wherein the intermediary device further comprises a microprocessor coupled to the interpreter, DC/DC converter, and interface and a memory coupled to the microprocessor.

14. The system of claim 13, wherein the microprocessor and memory are configured for storing the vehicular data in the memory when the mobile device is unavailable for receiving the vehicular data.

15. A method of sharing vehicular data of a vehicle using the intermediary device of claim 1, the method comprising:
delivering the vehicular data by the interpreter of the intermediary device, wherein the intermediary device is disposed in the vehicle;
translating, by the interpreter, the vehicular data into a format that can be understood by a mobile device; and
delivering the vehicular data from the intermediary device to the mobile device, wherein the mobile device is disposed in the vehicle.

16. The method of claim 15, further comprising transmitting the vehicular data from the mobile device to an external receiver which is external to the vehicle.

17. The method of claim 16, wherein the transmitting comprises transmitting GPS data with the vehicular data from the mobile device to the external receiver.

18. The method of claim 15, further comprising storing the vehicular data in a memory of the intermediary device.

19. The method of claim 18, wherein the delivering comprises delivering the vehicular data from the memory of the intermediary device to the mobile device.

20. The method of claim 15, further comprising charging the mobile device using power from the DC/DC converter of the intermediary device.
